(19) United States
(12) Patent Application Publication
(10) Pub. No.: US 2019/0296629 A1
(43) Pub. Date: Sep. 26, 2019

(54) HIGH TEMPERATURE SUPERCONDUCTING SYNCHRONOUS MACHINE WITH ROTATING ARMATURE

(71) Applicant: Thomas A. Lipo, Tallahassee, FL (US)

(72) Inventor: Thomas A. Lipo, Tallahassee, FL (US)

(73) Assignee: The Florida State University Research Foundation, Inc., Tallahassee, FL (US)

(21) Appl. No.: 16/361,595

(22) Filed: Mar. 22, 2019

Related U.S. Application Data
(60) Provisional application No. 62/646,479, filed on Mar. 22, 2018.

(51) Int. Cl. H02K 55/04; H01F 6/06; H02K 9/19

(52) U.S. Cl. CPC H02K 55/04; H02K 9/19; H01F 6/06

(57) ABSTRACT

Various embodiments are directed to a high temperature superconducting (HTS) synchronous machine having a rotating armature and methods for fabricating the same. The HTS synchronous machines described herein solve the rotating seal system complications which plague conventional HTS synchronous machines by eliminating entirely the need for any such system. Instead, it is proposed here to rotate the AC armature windings, which are stationary (i.e., normally the “stator”) in conventional HTS synchronous machines, while allowing the superconducting field windings to remain stationary.

### CROSS-REFERENCE TO RELATED APPLICATIONS

This application claims priority to U.S. Provisional Patent Application No. 62/646,479, filed Mar. 22, 2018, which is incorporated herein by reference.

### TECHNICAL FIELD

The present invention generally relates to the construction and operation of superconducting rotating machines. More specifically, the present invention relates to high temperature superconducting (HTS) synchronous machines.

### BACKGROUND

High temperature superconducting wire is being actively developed for a wide use of applications including circuit breakers, transmission lines, and magnetic energy storage. Another important application is found in the manufacture of high temperature superconducting (HTS) synchronous machines, in which high temperature superconducting wire replaces the typical field windings of a conventional synchronous machine.

Conventional synchronous machines have been available for decades, and include, but are not limited to, rotary generators, rotary motors, and linear motors. These synchronous machines include an armature and a field coil that produces a magnetic field. The armature consists of a series of current loops in the form of a coil that interacts with the magnetic flux produced by the field coil. Relative rotational motion between the armature and the field coil produces a generated voltage due to the rate of change of flux linkage in the armature coils. The power of such a machine is equal to the product of the generated voltage times the current in the armature coils.

An example synchronous machine is an AC motor in which, at steady state, the rotation of the shaft is synchronized with the frequency of the supply current. Synchronous machines generally include a stator and rotor that are electromagnetically coupled, and commonly rely on copper field windings. The electrical resistance of copper windings, although low by conventional measures, is sufficient to contribute to substantial heating of the rotor in a synchronous machine. This in turn diminishes the efficiency of the machine. Recently, superconducting (SC) field coil windings based on high temperature superconducting wire have been developed for rotors. SC windings have effectively no resistance and are highly advantageous rotor coil windings.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1A depicts a side perspective cross-sectional view of a HTS synchronous machine having a rotating outer armature in accordance with one or more example embodiments of the disclosure.

FIG. 1B depicts an orthogonal perspective cross-sectional view of a HTS synchronous machine having rotating outer armature in accordance with one or more example embodiments of the disclosure.

FIG. 1C depicts a front perspective cross-sectional view of a HTS synchronous machine having rotating outer armature in accordance with one or more example embodiments of the disclosure.

FIG. 2A depicts a side perspective cross-sectional view of a HTS synchronous machine having a rotating inner armature in accordance with one or more example embodiments of the disclosure.

FIG. 3 depicts an electronic circuit configured to feed an AC grid using a HTS synchronous machine in accordance with one or more example embodiments of the disclosure.

FIG. 4 depicts an alternative electronic circuit configured to feed an AC grid using a HTS synchronous machine in accordance with one or more example embodiments of the disclosure.

FIG. 5 depicts a front perspective cross-sectional view of a rotor of a HTS synchronous machine in accordance with one or more example embodiments of the disclosure.

FIG. 6 depicts a flow diagram of an illustrative method for providing a HTS synchronous machine having a rotating armature in accordance with one or more embodiments of the disclosure.

FIG. 7 depicts a magnetic flux density distribution of a HTS synchronous machine in accordance with one or more example embodiments of the disclosure.

FIGS. 8A to 8C depict example plots of back emf, current, and torque for a HTS synchronous machine in accordance with one or more example embodiments of the disclosure.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments, the various elements illustrated in the figures are provided with two or three digit reference numbers. With minor exceptions, the leftmost digit(s) of each reference number correspond to the figure in which its element is first illustrated.

### DETAILED DESCRIPTION

This disclosure relates to, among other things, a high temperature superconducting (HTS) synchronous machine with a rotating armature in contrast to the commonly employed rotating field winding. As used herein, an armature may refer to the combination of an armature frame (housing) and an armature winding. Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the disclosure to those skilled in the art. Like numbers refer to like, but not necessarily the same or identical, elements throughout.

The following embodiments are described in sufficient detail to enable at least those skilled in the art to understand and use the disclosure. It is to be understood that other embodiments would be evident based on the present disclosure and that process, mechanical, material, dimensional, process equipment, and parametric changes may be made without departing from the scope of the present disclosure.

In the following description, numerous specific details are given to provide a thorough understanding of various embodiments of the disclosure. However, it will be apparent that the disclosure may be practiced without these specific details. Moreover, to avoid obscuring the present disclosure, some well-known system configurations and process steps may not be disclosed in full detail. Likewise, the drawings showing embodiments of the disclosure are semi-diagrammatic and not to scale and, particularly, some of the dimensions may be exaggerated in the drawings for the clarity of presentation. In addition, where multiple embodiments are disclosed and described as having some features in common, for clarity and ease of illustration, description, and comprehension thereof, similar and like features will ordinarily be described with like reference numerals even if the features are not identical.

The term “horizontal” as used herein may be defined as a direction parallel to a reference plane or surface, regardless of its orientation. The term “vertical,” as used herein, may refer to a direction orthogonal to the horizontal direction as just described. Terms, such as “on,” “above,” “below,” “bottom,” “top,” “side” (as in “sidewall”), “higher,” “lower,” “upper,” “over,” and “under,” may be referenced with respect to a horizontal plane, where the horizontal plane can include an x-y plane, a x-z plane, or a y-z plane, as the case may be. The terms “on,” “over,” “above,” “higher,” “positioned on,” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary elements at the interface between the two elements.

“An embodiment,” “various embodiments,” and the like indicate embodiment(s) so described may include particular features, structures, or characteristics, but not every embodiment necessarily includes the particular features, structures, or characteristics. Some embodiments may have some, all, or none of the features described for other embodiments. “First,” “second,” “third,” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

The terms “perpendicular,” “orthogonal,” “coplanar,” and/or “parallel” may mean substantially perpendicular, orthogonal, coplanar, or parallel, respectively. For example, “perpendicular” can mean perpendicular within ±20, 15, 10, or 5 degrees. Further, the figures shown herein may not have precisely vertical or horizontal edges, but rather may have some finite slope and have surface roughness, as is to be expected for fabricated devices. The terms “about,” “substantially,” “approximately,” and variations thereof, are intended to include a degree of error associated with a measurement of the particular quantity using equipment available at the time of filing the application. For example, “about” can include a range of ±8% or 5%, or 2% of a given value.

As discussed previously herein, superconducting (SC) field coil windings based on high temperature superconducting wire have been developed to replace the field windings in conventional synchronous machines. High temperature superconducting (HTS) synchronous machines having these SC windings offer several advantages over conventional synchronous machines. One advantage is an increase in efficiency due in part to the SC field coil windings, which have effectively zero resistance. This in turn allows for the design of HTS synchronous machines having improved power densities relative to conventional synchronous machines.

There are challenges, however, in designing and operating HTS synchronous machines. While large scale HTS synchronous machines have been demonstrated at up to about 36.5 MW and 6.6 kV, progress has lagged due to the complexity of such a machine. One of the main challenges is the fact that conventional HTS synchronous machines employ a rotating field coil which is cooled using gaseous or liquid helium. In other words, the field windings of a conventional HTS synchronous machine must rotate. Moreover, these field windings must be kept at a sufficiently cold temperature to maintain superconductivity, and consequently, the liquid or gaseous coolant of the superconducting winding must be fed to, and extracted from, the rotor utilizing a complicated and unreliable rotating seal system. Typically, the coolant must be fed to the rotating shaft from a stationary refrigerant system by means of a complicated sliding cryo-cooler coupler. This coupler is prone to failure, reducing the life cycle and increasing costs associated with conventional HTS synchronous machines. In addition, current must be passed to the rotor for excitation of the superconducting cable, making the entire arrangement expensive and unreliable. These issues are clearly hindering the adoption of superconducting machines in the utility industry.

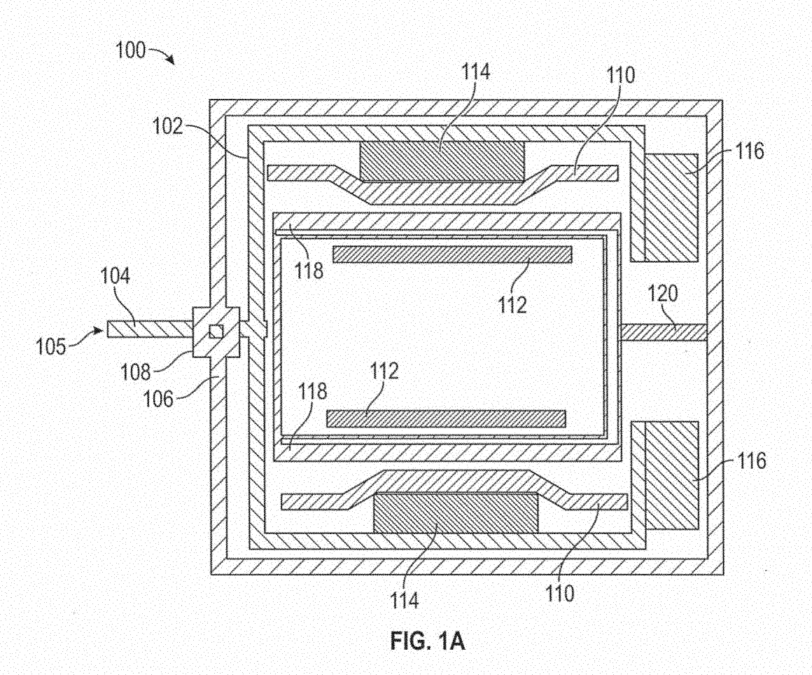

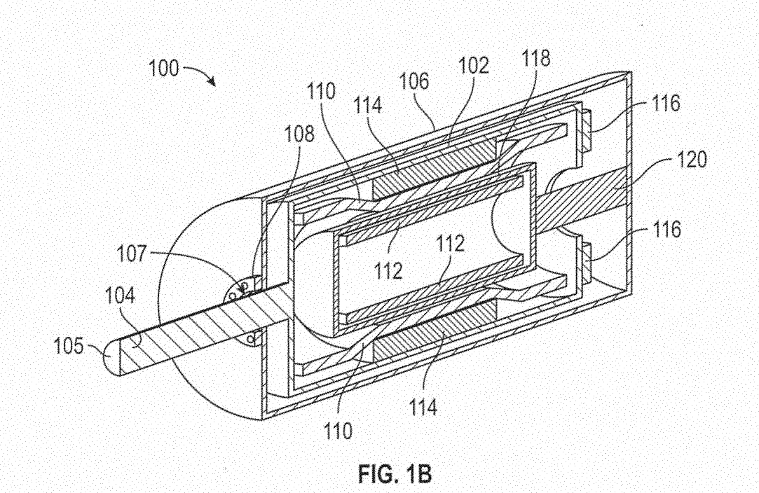

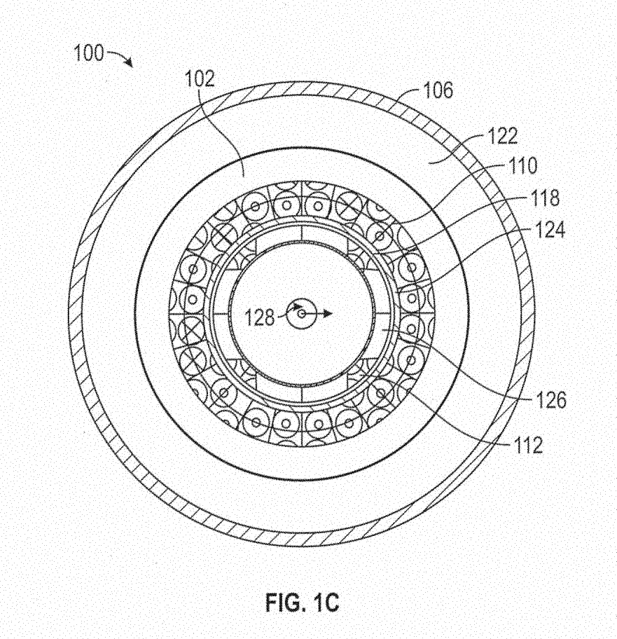

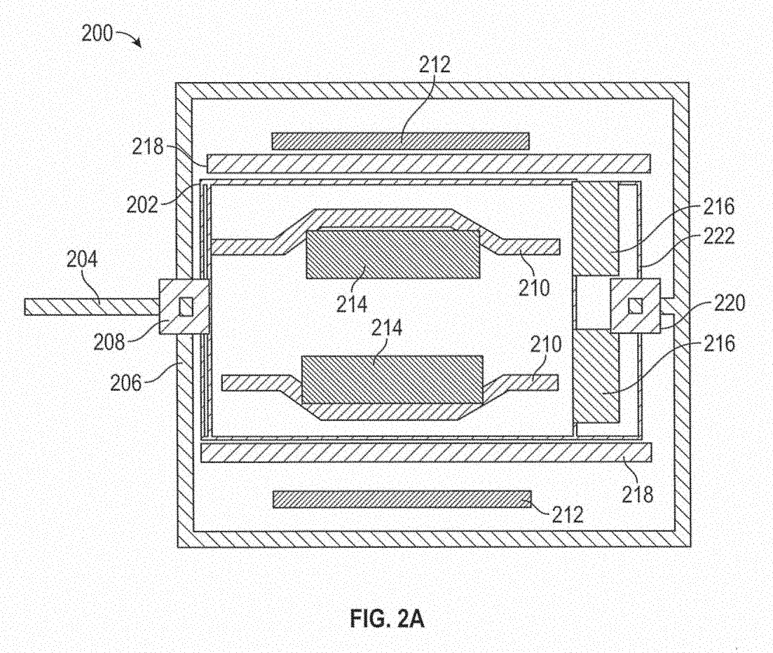

Turning now to aspects of the present disclosure, various embodiments described herein provide a HTS synchronous machine having a rotating armature and methods for fabricating the same. In some embodiments, the HTS synchronous machine may be a synchronous generator, or similar type of generator, that converts mechanical energy into electrical energy (an example application being a wind turbine). The HTS synchronous machines described herein solve the aforementioned rotating seal system problems which plague conventional HTS synchronous machines by eliminating entirely the need for any such system. Instead, it is proposed here to rotate the AC armature windings, which are stationary (i.e., normally the “stator”) in conventional HTS synchronous machines, while allowing the superconducting field windings to remain stationary. Such an arrangement inverts the conventional approach to the rotating parts of a synchronous machine, greatly simplifying the complexity of the superconducting coil, its coolant, fixtures, rotor support structure, and electromagnetic shield. The superconducting field windings are placed inside what is essentially a rotating cylindrical shell. The rotating armature can itself be configured as an outer armature (discussed below with reference to FIGS. 1A to 1C) or as an inner armature (discussed below with reference to FIG. 2A).

Eliminating the necessity of any complicated cryo-coolers that normally need to be rotated along with the superconducting windings results in a simpler, more reliable machine in terms of both operation and construction. Notably, such a machine still maintains a high efficiency, because of the use of superconducting coils has not fundamentally changed. Moreover, an HTS synchronous machine having a rotating armature allows for further simplifications, such as the elimination of the “torque tube” which is required in conventional machines to transfer torque from the cryogenic environment to the warm shaft ends. An HTS synchronous machine having a rotating armature can also eliminate the need for a low temperature bearing system.

Since the armature winding now rotates, power must be extracted from the armature windings via slip rings (also referred to as brushes). This can be accomplished in much the same manner as power is extracted from the field winding of a conventional HTS synchronous machine. In some embodiments, power is extracted from the rotating armature windings by employing a diode bridge which is fixed to, and rotates with, the armature. In some embodiments, the output of the diode bridge is DC. A DC output ensures that current can be readily collected via carbon slip rings in much the same manner as the field winding current of a conventional synchronous machine. This DC power can subsequently be fed to a solid-state inverter which then converts the power from DC to AC. In some embodiments, the DC power is converted to 60 Hz AC power, although other frequencies are within the contemplated scope of the disclosure.

Various illustrative embodiments have been discussed above. These and other example embodiments of the disclosure will be described in more detail hereinafter through reference to the accompanying drawings. The drawings and the corresponding description are provided merely for illustration and are not intended to limit the disclosure in any way. It should be appreciated that numerous other embodiments, variations, and so forth are within the scope of this disclosure.

FIG. 1A depicts a cross-sectional view of a side perspective of a HTS synchronous machine 100 having a rotating outer armature 102 in accordance with one or more example embodiments of the disclosure. In some embodiments, the outer armature 102 of the HTS synchronous machine 100 is coupled to a drive shaft 104. In this manner, rotation of the drive shaft 104 causes the outer armature 102 to rotate (whereas in typical synchronous machines the drive shaft would be coupled to the rotor instead of the armature). The drive shaft 104 can be coupled to a direct drive system or a geared drive system at one end 105 of the drive shaft 104, depending on the requirements of a given application. The direct drive system and/or geared drive system may serve to provide the necessary external force to rotate the drive shaft 104. Each drive system offers different advantages. Direct drive systems, which may rely upon a permanent magnet topology, can be less mechanically complex then a geared drive. This can result in easier operations and maintenance. Geared drive systems, on the other hand, may be cheaper, lighter, and can require a smaller footprint than equivalent direct drive systems. In some embodiments, the rotating drive shaft 104 may be coupled to a geared drive system having 1:6 gearboxes, although other configurations are within the contemplated scope of the disclosure. This arrangement is advantageous for some applications, such as wind turbines, which may rotate at a relatively slow revolutions per minute (rpm). For example, typical wind turbines operate at less than 50 rpm.

In some embodiments, the HTS synchronous machine 100 may include a fixed, stationary housing 106. The housing 106 may contain all of the components of the HTS synchronous machine 100 (e.g., field windings 112, armature windings 110, etc.), such that the outer armature 102 rotates within the housing 106. In some embodiments, the drive shaft 104 passes through an opening 107 (as depicted with reference to FIG. 1B) in the housing 106 and rotates freely using a bearings system 108. The bearings system 108 can include a plurality of bearings within a sleeve positioned between the drive shaft 104 and the housing 106. The bearings system 108 allows the drive shaft 104 to rotate the outer armature 102 without applying any rotational force to the housing 106 (so that the housing 106 may remain stationary).

In some embodiments, the outer armature 102 may include armature windings 110. In some embodiments, the armature windings 110 can be made using known processes and can include, for example, a series of wire loops that form a coil through which current may flow. In typical synchronous machines, the armature would be stationary. However, the outer armature 102 of the HTS synchronous machine 100 may rotate with the drive shaft 104. The HTS synchronous machine 100 may also include including one or more field windings 112. The one or more field windings 112 may include HTS wire. The field windings 112 may be wrapped around one or more core materials, or poles, (e.g., ferromagnetic or ferromagnetic material) to form electromagnetic poles. Thus, when current is provided to the field windings 112, a magnetic field may be induced in the poles. In the HTS synchronous machine 100, the field windings 112 may be located internally to the armature 102 and armature windings 110. In some embodiments, the poles may instead include one or more permanent magnets, and not include any windings. Either the field windings 112 or armature windings 110 may include HTS wire, and in some embodiments only non-rotating windings (e.g., the field windings 112) may include HTS wire, so as to reduce the complexity of requiring a rotating cryo-cooler for the HTS wire.

In some embodiments, the HTS synchronous machine 100 may produce an output current by inducing a current in the armature windings 110. This current may be fed to an AC grid (e.g., AC grid 302 or 402). The current may be induced in the armature windings 110 through electromagnetic interactions between the rotating armature windings 110 and the magnetic flux generated by the poles. In some embodiments, the magnetic flux produced by the poles may originate from permanent magnets, and in other embodiments the magnetic flux may originate from electromagnets including field windings 112. In the embodiments where field windings 112 are used, a current source (e.g., DC power supply) may be used to provide current to the field windings 112 in order to magnetize the core material and create the magnetic flux. The rotation of the armature windings 110 relative to the magnetic flux produced by the rotor induces a voltage across the armature windings 110, which in turn induces a current in the armature windings 110. Due to rotational effects, the voltage can be a sinusoidal-varying voltage. In some embodiments, the outer armature 102 may include at least one back iron 114. In some embodiments, a back iron 114 is constructed by wrapping magnetic wire around the armature windings 110, although other known configurations are within the contemplated scope of the disclosure.

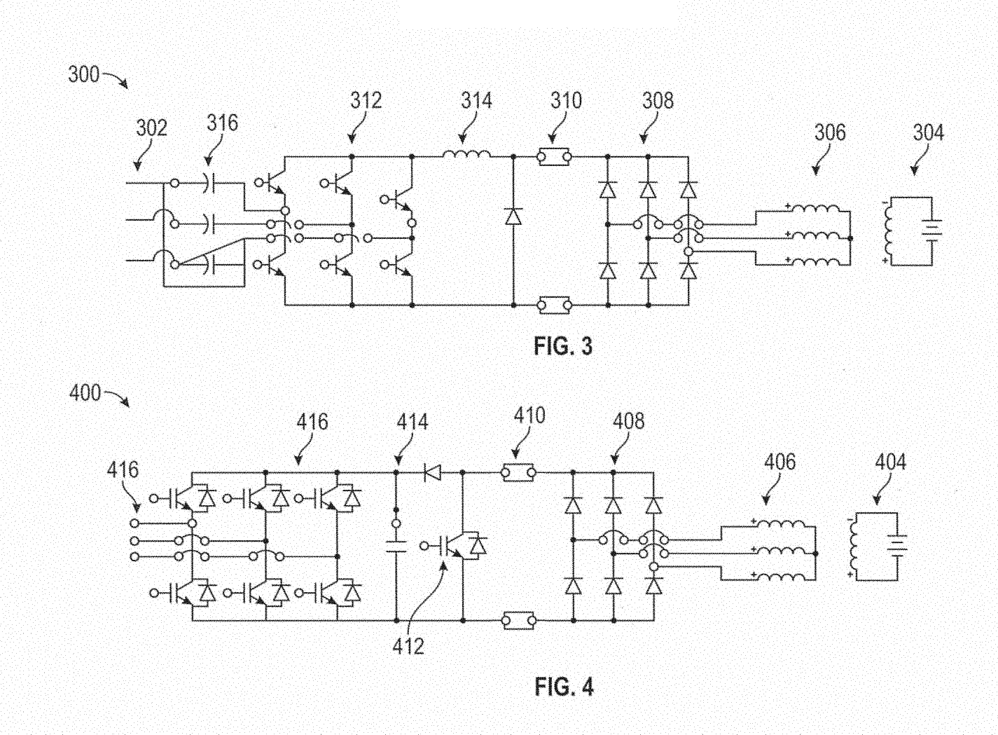

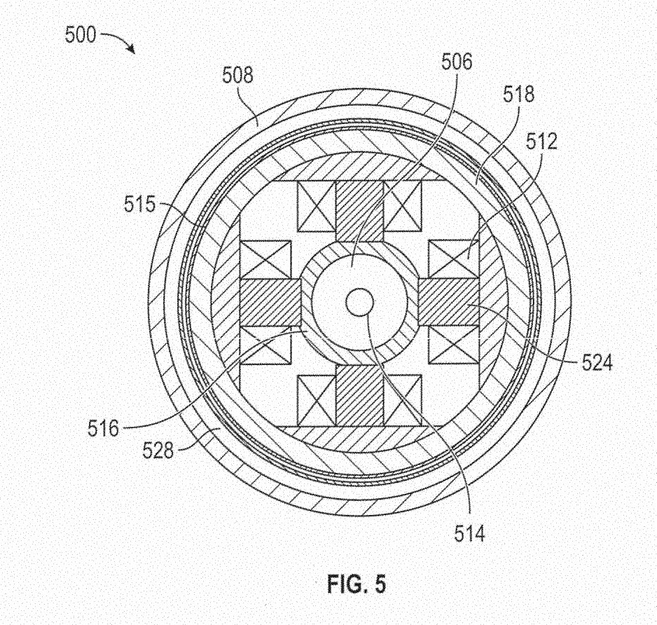

As discussed herein, in some embodiments the HTS synchronous machine 100 may be a HTS synchronous generator that can convert mechanical energy (e.g., rotation of the outer armature 102) into electrical energy (e.g., output current in the armature windings 110). The output current in the armature windings 110 can be extracted from the rotating armature windings 110 by employing a diode bridge 116 which is fixed to, and rotates with, the outer armature 102 (e.g., two alternative circuitry arrangements for converting the power extracted from the HTS synchronous machine 100 to AC for power grid are further described with reference to FIGS. 3 and 4). The diode bridge 116 may be a diode rectifier that serves to convert the AC current in the armature windings 110 into DC current. This DC current may be transferred from the output of the diode bridge 116 to the remaining circuitry through one or more slip rings. A slip ring may be an electrical connection that allows current to flow between a rotating element and a stationary element. The rotating element (which in this case may be the rotating outer armature 102) may contain conductive material located along the rotational path of the slip ring, which may be stationary. The slip ring may also be made of conductive material, and may be in contact with the conductive material located on the outer armature 102, so that current may be transferred from the outer armature 102 to the slip ring. The slip ring and outer armature 102 may be arranged relative to one another so that they are in sufficient contact for current transfer, while still allowing the outer armature 102 to feely rotate without being hindered by frictional forces.

In some embodiments, the field windings 112 are fixed within an electromagnetic shield 118, which is in turn fixed within the outer armature 102 (that is, the electromagnetic shield 118 is disposed of in between the field windings 112 and the outer armature 102). The field windings 112 and/or the electromagnetic shield 118 may secured to the housing 106 through a second, fixed shaft 120. The fixed shaft 120 may be coupled to the housing 106 and may extend through an opening in the outer armature 102, where it may then be coupled to the field windings 112 and/or electromagnetic shield 118, or any structure including the field windings 112 and/or electromagnetic shield 118. The electromagnetic shield 118 may serve to attenuate AC fields produced by the armature windings 110, and thus may reduce the impact of such AC fields on the field windings 112 or other rotor components.

The field windings 112 can be fabricated using known processes and materials. In some embodiments, the field windings 112 are made using a high temperature copper oxide ceramic superconducting material, such as bismuth strontium calcium copper oxide (Bi₂Sr₂Ca₂Cu₃Ox). In other embodiments, the field windings 112 is made using bismuth and lead based materials, such as (BiPb)₂. Other high temperature superconductor materials, including yttrium barium copper oxides (YBCO), YBCO variants where a rare earth element is substituted for the yttrium, thallium barium calcium copper oxides (TBCCO), and mercury barium calcium copper oxides (HGBCCO) are also within the scope of the disclosure. In some embodiments, the field windings 112 can be mounted to a support member, such as, for example, a stainless steel body.

The electromagnetic shield 118 can be similarly fabricated using known processes and materials. In some embodiments, the electromagnetic shield 118 includes known copper-based flux shields. In some embodiments, the outer armature 102 and/or the electromagnetic shield 118 are enclosed in a vacuum chamber, which isolates the cryogenically cooled field windings 112 from the surrounding components.

FIG. 1B depicts a cross-section of a HTS synchronous machine 100 from an orthogonal perspective in accordance with one or more example embodiments of the disclosure. In some embodiments, the HTS synchronous machine 100 with reference to FIG. 1B may have the same structure as the HTS synchronous machine 100 with reference to FIG. 1A. FIG. 1B may serve to illustrate the cylindrical (or similarly shaped) structure of the HTS synchronous machine 100. The same cylindrical shape may be applicable to any of the embodiments described herein (for example, HTS synchronous machine 200 of FIG. 2A).

FIG. 1C depicts a front perspective cross-sectional view of a HTS synchronous machine 100 in accordance with one or more example embodiments of the disclosure. The HTS synchronous machine 100 with reference to FIG. 1C may include at least some of the same components as the HTS synchronous machines with reference to FIGS. 1A and 1B. In some embodiments, the HTS synchronous machine 100 with reference to FIG. 1C may have the same structure as the HTS synchronous machine 100 with reference to FIGS. 1A and/or 1B. The HTS synchronous machine 100 with reference to FIG. 1C may not depict all of the elements of HTS synchronous machine 100 with reference to FIGS. 1A and 1B (e.g., drive shaft, bearing system 108, etc.), but these elements may still exist in the HTS synchronous machine 100 with reference to FIG. 1C. In some embodiments, the HTS synchronous machine 100 with reference to FIG. 1C may use superconducting coils for both the field windings 112 and armature windings 110. Key parameters used for the HTS synchronous machine 100 in some embodiments may be as provided below in Table 1.

TABLE 1

| | |
|---|---|
| Rated Output Power [MW] | 5 |
| Rated Frequency [Hz] | 4 |
| Rated Rotating Speed [RPM] | 120 |
| Back EMF L-L Induced(Peak) [kV] | 2.8 |
| Rated Output Voltage L-L [kV] | 2.9 |
| Rated Torque [kNm] | 398 |
| Efficiency [%] | 93 |
| Power Factor | 0.9 |
| Poles | 4 |
| Air Gap Field Peak [T] | 4.95 |
| Armature Current Density [A/mm2] | 4 |
| Physical Air Gap [mm] | 10 |
| Stator Inner Diameter [m] | 1.726 |
| Stator outer Diameter [m] | 3.1 |
| Stack Length [mm] | 1.726 |
| Stator Slots | 24 |
| Surface Current Density [A/mm] | 50 |

In some embodiments, this HTS synchronous machine 100 configuration may be used in low speed wind turbines or other low speed applications. A similar configuration using superconducting coils for both the field windings 112 and armature windings 110 may also be used with regards to the HTS synchronous machine 200 depicted in FIG. 2A having a rotating inner armature 202 instead of a rotating outer armature 102.

In some embodiments, the HTS synchronous machine 100 may have a rotating outer armature 102. In some embodiments, the outer armature of the HTS synchronous machine 100 may be coupled to a drive shaft 104 (as depicted with reference to FIGS. 1A and 1B). In this manner, rotation of the drive shaft 104 may cause the outer armature 102 to rotate. The drive shaft 104 can be coupled to a direct drive system or a geared drive system, depending on the requirements of a given application. Each drive system may offer certain advantages. For example, direct drive systems, which may rely upon a permanent magnet topology, can be less mechanically complex then a geared drive. This can result in easier operations and maintenance. As another example, geared drive systems may be cheaper, lighter, and can require a smaller footprint than equivalent direct drive systems. In some embodiments, the rotating drive shaft may be coupled to a geared drive system having 1:6 gearboxes, although other configurations are within the contemplated scope of the disclosure. This arrangement may be advantageous for some applications, such as wind turbines, which may rotate at a relatively slow revolutions per minute (rpm). For example, typical wind turbines which operate at less than 50 rpm.

In some embodiments, the outer armature may rotate within a fixed, stationary housing 106 (“housing”). The housing 106 may surround a vacuum space 122. In some embodiments, the drive shaft passes through an opening in the housing 106 and rotates freely using a bearings system (as depicted with reference to FIGS. 1A and 1B). The bearings system can include a plurality of bearings within a sleeve positioned between the drive shaft and the housing. The HTS synchronous machine 100 may also include an insulating layer 124 and rotor poles 126. The insulating layer 124 may serve to provide insulation for individual conductors.

In some embodiments, the outer armature 102 may include armature windings 110. The armature windings 110 can be made using known processes and can include, for example, a series of current loops that form a coil. The coil of the armature windings 110 may interact with the magnetic flux produced by a field winding 112 to generate a voltage. In some embodiments, the field windings 112 and the armature windings 110 may include HTS coils. Due to rotational effects, this voltage can be a sinusoidal-varying voltage. In some embodiments, the outer armature also includes a back iron (as depicted in FIGS. 1A and 1B). In some embodiments, the back iron is constructed by wrapping magnetic wire around the armature windings 110, although other known configurations are within the contemplated scope of the disclosure. As discussed previously herein, power can be extracted from the rotating armature windings 110 by employing a diode bridge (as depicted in FIGS. 1A and 1B) which is fixed to, and rotates with, the outer armature 102.

In some embodiments, the field windings 112 are fixed within an electromagnetic shield 118, which is, in turn, fixed within the outer armature 102. In some embodiments, the field windings 112 and the electromagnetic shield 118 may be coupled to the housing 106 using a second, fixed shaft 120 (as depicted in FIGS. 1A and 1B). The second, fixed shaft 120 may allow the field windings 112 and the electromagnetic shield 118 to remain stationary while the drive shaft rotates.

The HTS synchronous machine 100 may also include a coolant feed tube 128. The coolant feed tube 128 may provide coolant to the HTS wires of the HTS synchronous machine 100. In some embodiments, the coolant may include low temperature fluid or gas such as liquid nitrogen. In some embodiments, the coolant feed tube 128 may be stationary (not rotating) because the field windings 112 are also stationary. This may eliminate the complexity involved with having to provide a coolant feed tube 128 that would need to rotate in synch with rotating field windings 112 in order to properly cool the rotating field windings 112. The field windings 112 can be fabricated using known processes and materials. In some embodiments, the field windings 112 may be made using a high temperature copper oxide ceramic superconducting material, such as bismuth strontium calcium copper oxide (Bi₂Sr₂Ca₂Cu₃Ox). In other embodiments, the field windings 112 may be made using bismuth and lead based materials, such as (BiPb)₂. Other high temperature superconductor materials, including yttrium barium copper oxides (YBCO), YBCO variants where a rare earth element is substituted for the yttrium, thallium barium calcium copper oxides (TBCCO), and mercury barium calcium copper oxides (HGBCCO) are also within the scope of the disclosure. In some embodiments, the field windings 112 can be mounted to a support member, such as, for example, a stainless steel body.

The electromagnetic shield 118 can be similarly fabricated using known processes and materials. In some embodiments, the electromagnetic shield 118 includes known copper-based flux shields. In some embodiments, the outer armature and/or the electromagnetic shield 118 are enclosed in a vacuum chamber, which isolates the cryogenically cooled field windings 112 from the surrounding components.

FIG. 2A depicts a side perspective cross-sectional view of a HTS synchronous machine 200 having a rotating inner armature 202 in accordance with one or more example embodiments of the disclosure. The HTS synchronous machine 200 represents an alternative configuration of the HTS synchronous machine 100, where the rotating outer armature 102 is replaced with the rotating inner armature 202. The rotating inner armature 202 with reference to FIG. 2A may be similar to the rotating outer armature 102 with reference to FIG. 1A, but the rotating inner armature 202 may be different in that the field windings 212 with reference to FIG. 2A are external to the rotating inner armature 202, whereas the field windings 112 with reference to FIG. 1A are internal to the rotating outer armature 102. The HTS synchronous machine 200 may also include many of the same components as the HTS synchronous machine 100. For example, drive shaft 204 of FIG. 2A may be similar to drive shaft 104 of FIG. 1A. The same may apply to any of the other components of FIG. 2A with reference to FIG. 1A.

In some embodiments, the inner armature 202 of the HTS synchronous machine 200 is coupled to a drive shaft 204. In this manner, rotation of the drive shaft 204 causes the inner armature 202 to rotate. The drive shaft 204 can be coupled to a direct drive system or a geared drive system, in a similar manner as the drive shaft 104 of the HTS synchronous machine 100.

In some embodiments, the HTS synchronous machine 200 may include a fixed, stationary housing 206. The housing 206 may contain all of the components of the HTS synchronous machine 200 (e.g., field windings 212, armature windings 210, etc.), such that the inner armature 202 rotates within the stationary housing 206. In some embodiments, the drive shaft 204 passes through an opening in the housing 206 and rotates freely using a bearings system 208. The bearings system 208 can include a plurality of bearings within a sleeve positioned between the drive shaft 204 and the housing 206. The bearing system 208 allows the drive shaft 204 to rotate the inner armature 202 without applying any rotational force to the housing 206.

In some embodiments, the inner armature 202 may include armature windings 210. In some embodiments, the armature windings 210 can be made using known processes and can include, for example, include a series of wire loops that form a coil through which current may flow. In typical synchronous machines, the armature would be stationary. However, the inner armature 202 of the HTS synchronous machine 200 may rotate with the drive shaft 204. The HTS synchronous machine 200 may also include one or more field windings 212. The one or more field windings 212 may include HTS wire. The field windings 212 may be wrapped around one or more core materials (e.g., ferromagnetic or ferromagnetic material) to form electromagnetic poles. Thus, when current is provided to the field windings 212, a magnetic field may be induced in the poles. In some embodiments, the poles may instead include one or more permanent magnets. Either the field windings 212 or armature windings 210 may include HTS wire, and in some embodiment, only non-rotating windings (e.g., the field windings 212) include HTS wire, so as to reduce the complexity of requiring a rotating cryo-cooler for the HTS wire.

In some embodiments, the HTS synchronous machine 200 may produce an output current by inducing a current in the armature windings 210. The current may be induced in the armature windings 210 through electromagnetic interactions between the rotating armature windings 210 and the magnetic flux generated by the poles. In some embodiments, the magnetic flux produced by the rotor may originate from permanent magnets, and in other embodiments, the magnetic flux may originate from electromagnetic poles that include field windings 212. In the embodiments where field windings 212 are used, a current source (e.g., DC power supply) may be required to provide current to the field windings 212 in order to magnetize the core material and create the magnetic flux. The rotation of the armature windings 210 relative to the magnetic flux produced by the rotor induces a voltage across the armature windings 210, which in turn induces a current in the armature windings 210. Due to rotational effects, the voltage can be a sinusoidal-varying voltage. In some embodiments, the inner armature 202 may also include at least one back iron 214. In some embodiments, a back iron 214 is constructed by wrapping magnetic wire around the armature windings 210, although other known configurations are within the contemplated scope of the disclosure.

As discussed previously herein, in some embodiments the HTS synchronous machine 200 may be a HTS synchronous generator that converts mechanical energy (rotation of the inner armature 202) into electrical energy (output current in the armature windings 210). The output current in the armature windings 210 can be extracted from the rotating armature windings 210 by employing a diode bridge 216 which is fixed to, and rotates with, the inner armature 202 (two alternative circuitry arrangements for converting the power extracted from the HTS synchronous motor to AC for power grid are further described with regards to FIGS. 3 and 4). The diode bridge 216 may be a diode rectifier that serves to convert the AC current in the armature windings 210 into DC current. This DC current may be transferred from the output of the diode bridge 216 to the remaining circuitry through one or more slip rings. A slip ring may be an electrical connection that allows current to flow between a rotating element and a stationary element. The rotating element (which in this case may be the rotating inner armature 202) may contain conductive material located along the rotational path of the slip ring, which may be stationary. The slip ring may also be made of conductive material, and may be in contact with the conductive material located on the inner armature 202, so that current may be transferred from the inner armature 202 to the slip ring. The slip ring and inner armature 202 may be arranged relative to one another so that they are in sufficient contact for current transfer, while still allowing the inner armature 202 to feely rotate without being hindered by frictional forces.

While similar, the HTS synchronous machine 200 having a rotating inner armature 202 differs from the HTS synchronous machine 100 in several key respects. In some embodiments, the field windings 212 are fixed within the housing 206, outside of an electromagnetic shield 218. In some embodiments, the field windings 212 and the electromagnetic shield 218 may each be coupled or otherwise directly fixed to the housing 206. The electromagnetic shield 218 may serve to attenuate AC fields produced by the armature windings 210, and thus reduce the impact of such AC fields on the field windings 212 or other rotor components. In this configuration a second bearings system 220 is not required, but can be used in conjunction with the bearings system 208 to support the inner armature 202. In some embodiments, the HTS synchronous machine 200 includes a torque tube 222. The torque tube 222 allows for the transfer of torque from the drive shaft 204 to the rotating inner armature 202.

The field windings 212 can be fabricated using known processes and materials. In some embodiments, the field windings 212 is made using a high temperature copper oxide ceramic superconducting material, such as bismuth strontium calcium copper oxide (Bi₂Sr₂Ca₂Cu₃Ox). In other embodiments, the field windings 212 is made using bismuth and lead based materials, such as (BiPb)₂. Other high temperature superconductor materials, including yttrium barium copper oxides (YBCO), YBCO variants where a rare earth element is substituted for the yttrium, thallium barium calcium copper oxides (TBCCO), and mercury barium calcium copper oxides (HGBCCO) are also within the scope of the disclosure. In some embodiments, the field windings 212 can be mounted to a support member, such as, for example, a stainless steel body.

The electromagnetic shield 218 can be similarly fabricated using known processes and materials. In some embodiments, the electromagnetic shield 218 includes known copper-based flux shields. In some embodiments, the inner armature 202 and/or the electromagnetic shield 218 are enclosed in a vacuum chamber, which isolates the cryogenically cooled field windings 212 from the surrounding components.

FIG. 3 depicts an electronic circuit 300 configured to feed an AC grid 302 using a HTS synchronous machine in accordance with one or more example embodiments of the disclosure. As described previously, the HTS synchronous machine may be a HTS synchronous generator that converts mechanical energy into the electrical energy necessary to feed the AC grid 302. In some embodiments, the HTS synchronous generator may be supplied in a wind turbine that provides the mechanical energy. As depicted in FIG. 3, the circuit 300 includes a stationary superconducting field windings 304 electromagnetically coupled to rotating armature windings 306 (the field winding 304 and armature windings 306 may include the field windings 212 and the armature windings 210). The superconducting field winding 304 can be formed in a similar manner as the field windings 212 of the HTS synchronous machine 100 having a rotating outer armature 102 or as the field windings 212 of the HTS synchronous machine 200 having a rotating inner armature 202, according to one or more embodiments of the disclosure. Similarly, the rotating armature windings 306 can be coupled to an outer armature (as described with reference to FIGS. 1A to 1C) or an inner armature (as described with reference to FIG. 2A), according to one or more embodiments of the disclosure. As described previously, an output current may be induced in the armature windings 306 through interactions between the rotating armature windings 306 and a magnetic flux produced by the rotor (e.g., through the field windings 306).

In some embodiments, the rotating armature windings 306 are in turn electrically coupled to a diode bridge 308. The diode bridge 308 can be configured similarly to the diode bridge 216 (as described with reference to FIGS. 1A to 1C) or the diode bridge 216 (as described with reference to FIG. 2A), depending on the armature configuration chosen. Current is extracted from the armature windings 306 via slip rings 310 (also referred to as brushes). This can be accomplished in much the same manner as current is extracted from the field winding of a conventional HTS synchronous machine. The diode bridge 308 may be a diode rectifier that serves to convert the AC current in the armature windings 306 into DC current. This DC current may be transferred from the output of the diode bridge 308 to the remaining circuitry through one or more slip rings 310. A slip ring may be an electrical connection that allows current to flow between a rotating element and a stationary element. The rotating element (which in this case may be the rotating outer armature 102) may contain conductive material located along the rotational path of the slip ring, which may be stationary. The slip rings 310 may also be made of conductive material, and may be in contact with the conductive material located on the outer armature 102, so that current may be transferred from the outer armature 102 to the slip rings 310. The slip rings 310 and outer armature 102 may be arranged relative to one another so that they are in sufficient contact for current transfer, while still allowing the outer armature 102 to feely rotate without being hindered by frictional forces.

In some embodiments, the slip rings 310 are electrically coupled to an inverter 312 using a DC link 314. A DC link is a connection which electrically couples a rectifier and an inverter. In some embodiments, the inverter 312 is a 3-phase transistorized inverter, although other configurations are within the contemplated scope of the disclosure. The output of the inverter 312 is fed to a capacitor filter 316, which allows the output voltage to be smoothed prior to feeding the AC grid 302.

FIG. 4 depicts an electronic circuit 400 configured to feed an AC grid 402 using a HTS synchronous machine in accordance with one or more example embodiments of the disclosure. As described previously, the HTS synchronous machine may be a HTS synchronous generator that converts mechanical energy into the electrical energy necessary to feed the AC grid 302. In some embodiments, the HTS synchronous generator may be supplied in a wind turbine that provides the mechanical energy. The electronic circuit 400 represents an alternative configuration of the electronic circuit 300. As depicted in FIG. 4, the circuit 400 includes a stationary superconducting field winding 404 electromagnetically coupled to rotating armature windings 406 (the field winding 404 and armature windings 406 may include the field windings 212 and 212 and the armature windings 210 and 210). The superconducting field winding 404 can be formed in a similar manner as the field windings 212 of the HTS synchronous machine 100 having a rotating outer armature 102 or as the field windings 212 of the HTS synchronous machine 200 having a rotating inner armature 202, according to one or more embodiments of the disclosure. Similarly, the rotating armature windings 406 can be coupled to an outer armature (as described with reference to FIGS. 1A to 1C) or an inner armature (as described with reference to FIG. 2A), according to one or more embodiments of the disclosure. As described previously, an output current may be induced in the armature windings 406 through interactions between the rotating armature windings 406 and a magnetic flux produced by the rotor (e.g., through the field windings 406).

In some embodiments, the rotating armature windings 406 are in turn electrically coupled to a diode bridge converter 408. The diode bridge converter 408 can be configured similarly to the diode bridge 216 (as described with reference to FIGS. 1A to 1C) or the diode bridge 216 (as described with reference to FIG. 2A), depending on the armature configuration chosen. Power is extracted from the armature windings 406 via slip rings 410 (also referred to as brushes). This can be accomplished in much the same manner as power is extracted from the field winding of a conventional HTS synchronous machine. The diode bridge 408 may be a diode rectifier that serves to convert the AC current in the armature windings 406 into DC current. This DC current may be transferred from the output of the diode bridge 408 to the remaining circuitry through one or more slip rings 410. A slip ring may be an electrical connection that allows current to flow between a rotating element and a stationary element. The rotating element (which in this case may be the rotating inner armature 202) may contain conductive material located along the rotational path of the slip ring, which may be stationary. The slip rings 410 may also be made of conductive material, and may be in contact with the conductive material located on the inner armature 202, so that current may be transferred from the inner armature 202 to the slip rings 410. The slip rings 410 and inner armature 202 may be arranged relative to one another so that they are in sufficient contact for current transfer, while still allowing the inner armature 202 to feely rotate without being hindered by frictional forces.

In some embodiments, the slip rings 410 are electrically coupled to a boost chopper 412. The boost chopper 412 smooths and increases the output voltage from the slip rings 410 prior to feeding a capacitor bank 414. The capacitor bank 414 provides a steady state output that can feed an inverter 416. In some embodiments, the inverter 416 is a 3-phase transistorized inverter, although other configurations are within the contemplated scope of the disclosure. In some embodiments, the output of the inverter 416 is fed directly to the AC grid 402 using a step up transformer (not depicted).

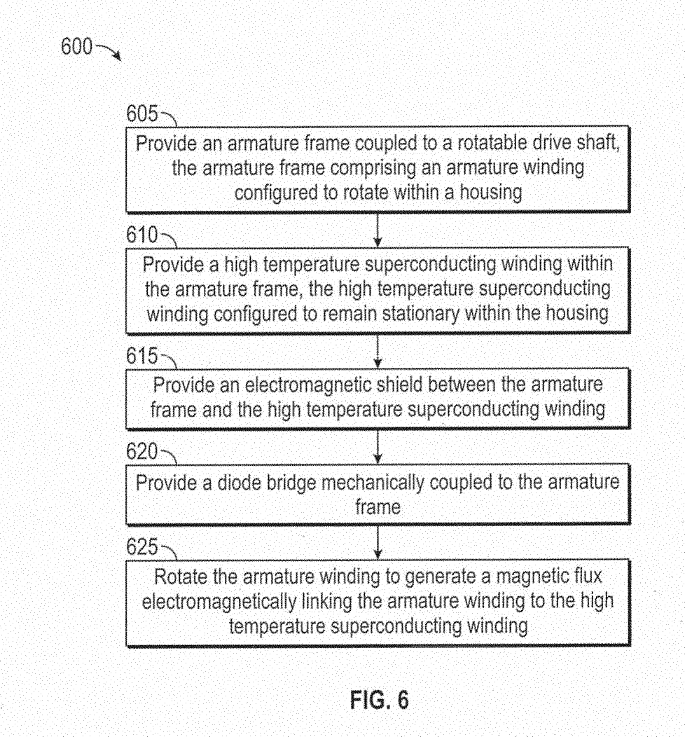

FIG. 5 depicts a front perspective cross-sectional view of a rotor 500 of a HTS synchronous machine in accordance with one or more example embodiments of the disclosure. The rotor depicted in FIG. 5 may not be representative of any rotor or other structure found herein (at least with reference to FIGS. 1A to 1C and 2A). This cross-sectional view may serve to illustrate the complexity of a rotor configuration found in a HTS synchronous machine, and why adding the additional factor of a cooling system rotating in sync with the rotor to cool the field windings 512 may prove difficult. For example, the rotor 500 may include a core tube 506 surrounding a coolant feed tube 514. Attached to the core tube 506 may be one or more magnetic poles 524 including field windings 512. The field windings 512 may be wrapped around the magnetic poles 524 so as to form electromagnets. The magnetic poles 524 may be surrounding surrounded by an electromagnetic shield 518. The electromagnetic shield 518 may further be surrounding surrounded by multi insulation layer (MLI) 515. The MLI 515 may be surrounded by a vacuum space 510. The vacuum space 510 may be surrounded by a SS outer wall 508.

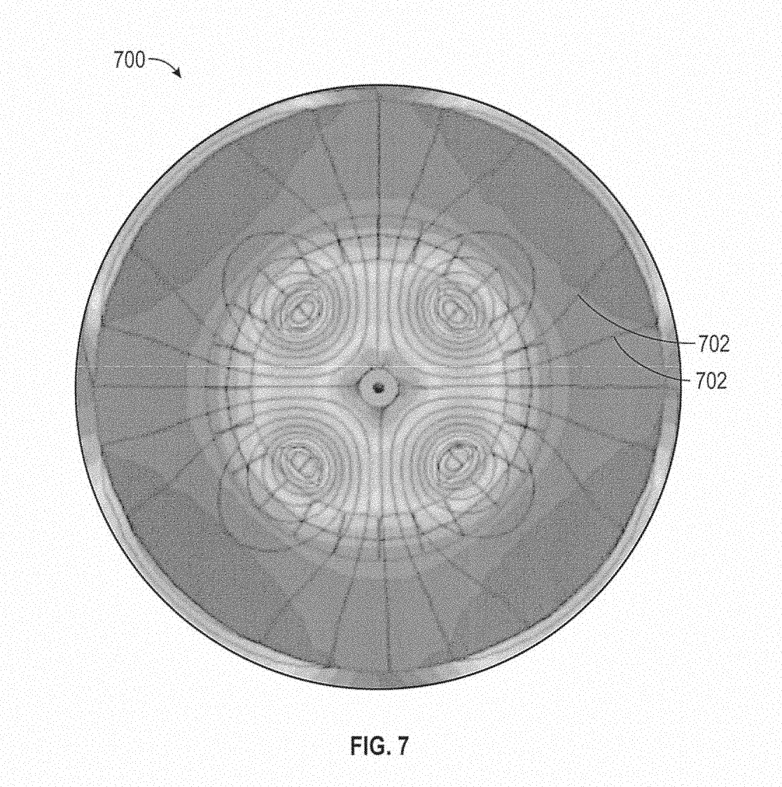

Now referring to FIG. 6, a flow diagram of an illustrative method 600 for providing a HTS synchronous machine having a rotating armature in accordance with one or more embodiments of the disclosure is depicted. At block 605, an armature frame coupled to a rotatable drive shaft is provided. The armature frame can be an outer armature (as described with reference to FIGS. 1A to 1C) or an inner armature (as described with reference to FIG. 2A), according to one or more embodiments of the disclosure. In some embodiments, the armature frame includes an armature winding configured to rotate within a housing. In some embodiments, the housing is stationary.

At block 610, a high temperature superconducting winding is provided within the armature frame. As described previously herein, the high temperature superconducting winding can be configured to remain stationary within the housing.

At block 615, an electromagnetic shield is provided between the armature frame and the high temperature superconducting winding. The electromagnetic shield can be configured similarly to the electromagnetic shield 118 (as described with reference to FIGS. 1A to 1C) or as the electromagnetic shield 118 (as described with reference to FIG. 2A), according to one or more embodiments of the disclosure.

At block 620, a diode bridge is mechanically coupled to the armature frame. The diode bridge can be configured similarly to the diode bridge 116 (as described with reference to FIGS. 1A to 1C) or as the diode bridge 6 (as described with reference to FIG. 2A), according to one or more embodiments of the disclosure.

At block 625, the armature winding is rotated to generate a magnetic flux electromagnetically linking the armature winding to the high temperature superconducting winding, according to one or more embodiments of the disclosure.

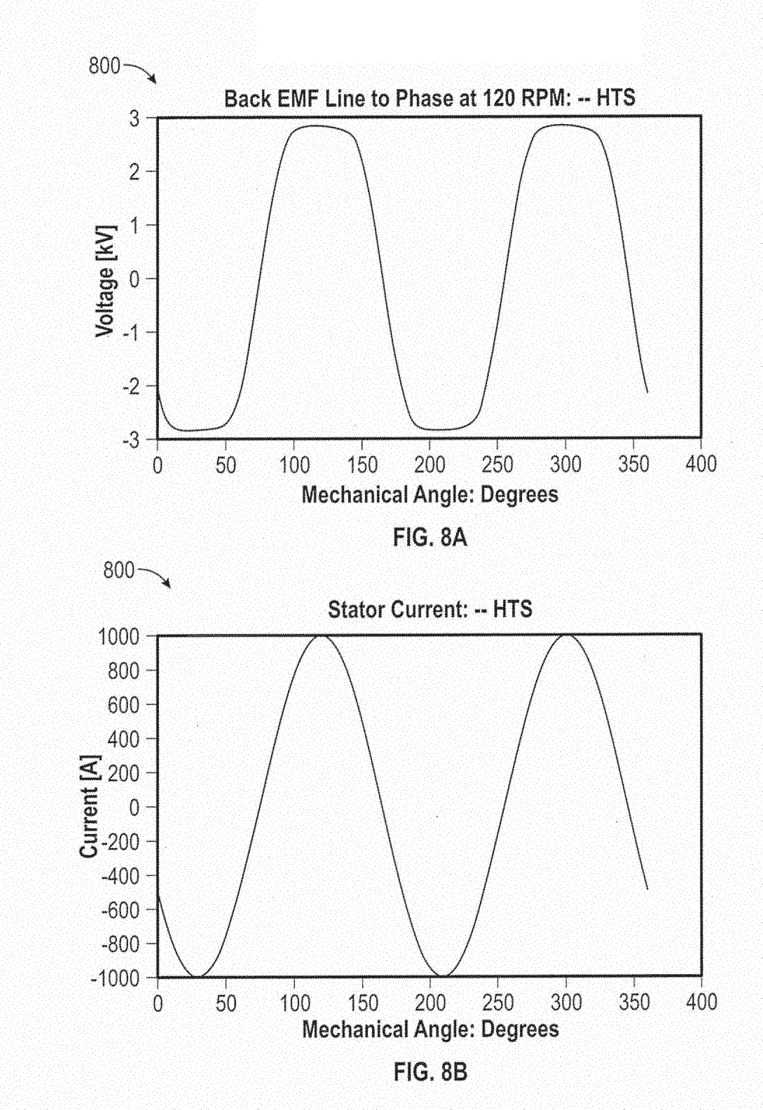

FIG. 7 depicts a magnetic flux density distribution plot 700 in accordance with one or more example embodiments of the disclosure. The magnetic flux density distribution plot 700 may include one or more magnetic flux lines 702. In some embodiments, the depicted magnetic flux density distribution plot 700 may be for the HTS synchronous machine 100 depicted in FIG. 1C (however, a similar magnetic flux density distribution may be found in HTS synchronous machine 100 with reference to FIGS. 1A and 1B, and HTS synchronous machine 200 with reference to FIG. 2A). The depicted magnetic flux density distribution plot 700 may also be for a HTS synchronous machine under a no load condition.

The performance of the HTS synchronous machine 100 was evaluated under a no load condition. In one example evaluation, the peak field density at the air gap was 4.5 T and the region around the superconductor had a maximum field density of 7.5 T. A torque ripple that was obtained was significant with an air gap ripple flux density of 6-8%. The flux density of the HTS machine has a significantly high value of 3.5 T with an air gap of 10 mm, which did not include the width of the HTS shield and the armature winding shields.

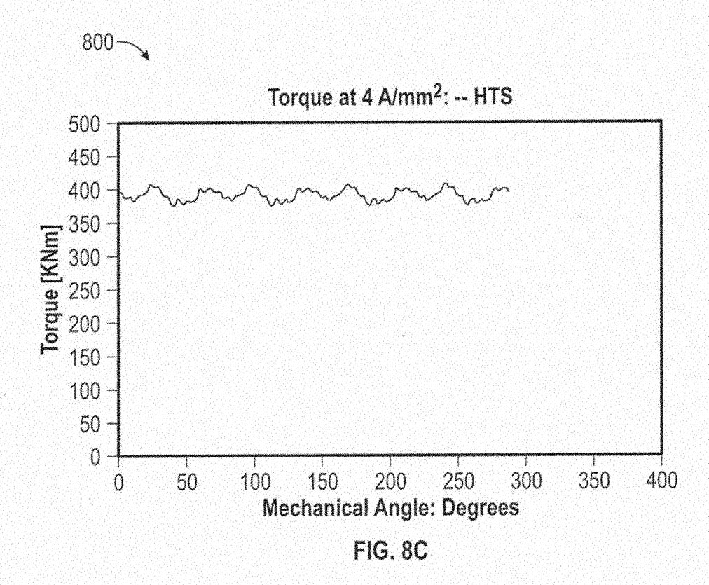

FIGS. 8A, 8B and 8C depict example plots 800 of back electromagnetic force (emf), current, and torque for a HTS synchronous machine in accordance with one or more example embodiments of the disclosure. FIG. 8A depicts a phase voltage showing a nearly sinusoidal induced voltage. FIG. 8B displays a rated armature current of about 1000 A peak. FIG. 8C displays a relatively small ripple torque.

With reference to all embodiments referenced herein, the terms “rotate”, “stationary”, or any similar terms may be relative terms. For example, the rotation of the armature (both outer and/or inner) may be relative to the housing and/or the field windings. Likewise, the house and/or field windings may be stationary relative to the armature (both outer and/or inner).

### Use Cases: Wind Turbines

The applications for a HTS synchronous machine having a rotating armature according to one or more embodiments of this disclosure are varied. Notably, the application of the rotating armature concept to wind turbine generators is particularly attractive since the armature of the machine can be designed to rotate along with the wind turbine blades, achieving further simplifications and efficiencies. Also, since wind turbines only operate at a few rpm (e.g., 5, 10, 15, 20, 25, 50 rpm), the AC power is generated at a very low frequency. This in turn raises the possibility of having the armature windings superconducting as well as the field winding. In other words, in some embodiments, the armature windings 110 (discussed with reference to FIGS. 1A to 1C) or the armature windings 110 (discussed with reference to FIG. 2A) can be made of superconducting materials. With this in mind, it is proposed that a HTS synchronous machine having a rotating armature may be suitable for offshore wind turbine applications. As the armature of the machine can be designed to rotate along with the wind turbine blades, the conventionally high COE (Cost of Energy) associated with superconducting machines can be reduced.

As discussed previously herein, a geared drive or direct drive system could be used in such a configuration. A common debate in wind power generation for decades has been the choice between a geared drive and a direct drive system. With the advent of power electronics over the years, the direct drive topology, which is less complex physically than a geared drive, has been gaining acceptance in wind turbine systems. On the other hand, geared drives allow for offshore wind power generation systems which are less complicated technically, and which rely upon proven technologies.

When geared drives are chosen, in general, two stage, 1:6 gearboxes are the most desirable for power generation purposes. In particular, the D2L of this type of geared machine will be roughly ⅙ that of an equivalent direct drive system, with further cost and weight reductions resulting from the smaller, cheaper to fabricate geared drive system. Moreover, due to the low operational rpms of typical wind turbines, a geared drive may obtain a better torque output than the permanent magnet direct drive machines available at present in the market. A 1:6 gearbox coupled to a typical wind turbine blade spinning between about 10 and 50 rpm will convert this rotation to about 60 to 300 rpm.

Regardless of the type of drive system used, in some embodiments, the HTS synchronous machine will include a DC to DC converter, slip rings on the line, and diode bridge rectifier to produce a power adequate to be fed to the grid. In some embodiments, a battery storage system and a feedback loop for the power supply to the converters can be integrated with the HTS synchronous machine, resulting in a standalone power generation system for offshore applications.

In some embodiments, a 5MW wind turbine system comprising a HTS synchronous machine having a rotating armature can be provided, although other power generation capabilities are within the contemplated scope of the disclosure. The key parameters for such a system may include, for example, a Rated Output Power of 5 MW, a Rated Frequency of 4 Hz, a Rated Rotating Speed of 120 RPM, a Back EMF L-L Induced (Peak) of 2.8 kV, a Rated Output Voltage L-L of 2.9 kV, a Rated Torque of 398 kNm, an Efficiency of 93%, a Power Factor of 0.9, four poles, an Air Gap Field Peak of 4.95 T, an Armature Current Density of 4 A/mm2, a Physical Air Gap of 10 mm, a Stator Inner Diameter of 1.726 m, a Stator Outer Diameter of 3.1 m, a Stack Length of 1.726 mm, 24 Stator Slots, and a Surface Current Density of 50 A/mm.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A machine comprising:
an armature frame coupled to a rotatable drive shaft, the armature frame comprising an armature winding configured to rotate within a housing; and
a high temperature superconducting winding within the armature frame, wherein the high temperature superconducting winding remains stationary within the housing while the armature frame rotates.

2. The machine of claim 1, wherein rotation of the armature winding generates a magnetic flux electromagnetically linking the armature winding to the high temperature superconducting winding.

3. The machine of claim 2, wherein the electromagnetic linking between the armature windings and the high temperature superconducting winding induces a current in the armature winding.

4. The machine of claim 1, further comprising an electromagnetic shield between the armature frame and the high temperature superconducting winding.

5. The machine of claim 1, further comprising a diode bridge mechanically coupled to the armature frame.

6. A machine comprising:
an armature frame coupled to a rotatable drive shaft, the armature frame comprising an armature winding configured to rotate within a housing; and
a high temperature superconducting winding between the armature frame and the housing, wherein the high temperature superconducting winding remains stationary within the housing while the armature frame rotates.

7. The machine of claim 6, wherein rotation of the armature winding generates a magnetic flux electromagnetically linking the armature winding to the high temperature superconducting winding.

8. The machine of claim 7, wherein the electromagnetic linking between the armature windings and the high temperature superconducting winding induces a current in the armature winding.

9. The machine of claim 6, further comprising an electromagnetic shield between the armature frame and the high temperature superconducting winding.

10. The machine of claim 6, further comprising a diode bridge mechanically coupled to the armature frame.

16. A method comprising:
providing an armature frame coupled to a rotatable drive shaft, the armature frame comprising an armature winding configured to rotate within a housing; and
providing a high temperature superconducting winding within the armature frame, the high temperature superconducting winding configured to remain stationary within the housing.

17. The method of claim 16, further comprising rotating the armature winding to generate a magnetic flux electromagnetically linking the armature winding to the high temperature superconducting winding.

18. The method of claim 16, wherein the machine comprises a high temperature superconducting synchronous machine.

19. The method of claim 16, further comprising providing an electromagnetic shield between the armature frame and the high temperature superconducting winding.

20. The method of claim 16, further comprising providing a diode bridge mechanically coupled to the armature frame.
